(19) United States
(12) Patent Application Publication
(10) Pub. No.: US 2013/0276406 A1
(43) Pub. Date: Oct. 24, 2013

(54) APPARATUS AND METHODS FOR USING RECYCLED MATERIAL IN THE FABRICATION OF PRECAST ARCHITECTURAL PRODUCTS

(71) Applicant: Mark Coate, Riverside, CA (US)

(72) Inventor: Mark Coate, Riverside, CA (US)

(73) Assignee: PRESTIGE ARCHITECTURAL PRODUCTS, Riverside, CA (US)

(21) Appl. No.: 13/453,155

(22) Filed: Apr. 23, 2012

(51) Int. Cl. E04F 19/02; C04B 38/00; C04B 18/06; B28B 23/00

(52) U.S. Cl. 52/745.21; 249/98; 106/672; 106/679

(57) ABSTRACT

This disclosure relates to devices and methods for the manufacture and installation of precast architectural products derived from recycled materials. Preferably, the precast products are comprised of recycled foam material that may be derived from scrap material or used mold components. The recycled devices and methods utilize a two-step ledger system to help install architectural products that would otherwise require mechanical fasteners because of the weight of the precast piece. To be used with a ledger, the architectural products disclosed herein comprise a channel or indentation configured to receive and rest on the ledger. Also disclosed is a mold for precast architectural products that can itself form a part of the recycled foam material used in the mixture that forms precast architectural products.

### BACKGROUND

1. Field

Various embodiments disclosed herein relate generally to methods for the fabrication of precast recycled foam architectural products as well as the products themselves and methods of installing those products.

2. Description of the Related Art

The use of natural cut and carved stone is often too expensive to be used in most homes and buildings. Natural stone is also heavy and subject to seismic limitations. Over the years, various products and construction methods have been developed to simulate cut and carved stone on home and building exteriors. For example, many commercially available cementitious products may be used to prepare three-dimensional shapes, which when cured, may serve as window sills, crown moldings, window surrounds, moldings around doors wall caps, keystones, columns, column caps and bases, etc. With limitations similar to natural stone, architectural stone products may be produced by casting cementitious material in a mold to produce cast solid architectural stone products. Others cover foam shapes with a thin layer of cementitious material, either at a jobsite or at a shop. Similar to stone, cast solid architectural stone products are heavy and expensive because of the amount of cementitious material required to fabricate the product.

Because of their weight, many products require the use of mechanical fasteners either for permanent installation or at least for support while an adhesive cures or sets. Mechanical fasteners, however, can damage surfaces and pierce or puncture waterproof layers, thereby creating the possibility that water could enter a wall or the architectural product itself and later require repair.

### SUMMARY

The embodiments described herein generally relate to methods of manufacturing and installing precast architectural foam products as well as relating to the products themselves. In some embodiments, a reusable mold for a precast architectural product is disclosed that comprises an interior space having at least one contoured surface, a liner adhered to at least a portion of the at least one contoured surface, and a placeholder configured to create a channel in the precast architectural product. In some embodiments of a reusable mold, the placeholder is configured to attach to the mold. In some embodiments of a reusable mold, the liner comprises a polyurethane material. In some embodiments, a release agent is applied to an exterior surface of the liner. In some embodiments, an adhesive is used to adhere at least a portion of the liner to the mold. In some embodiments, the reusable mold comprises a foam material, which in some cases is suitable for use as a component in a precast architectural product.

Some embodiments disclosed herein relate to a mixture for a precast architectural product comprising recycled foam, sand, cement, and water. In some embodiments, the mixture also contains at least one additive and, in some cases, at least one pigment. In some embodiments, the additive is a water-reducing agent. In some embodiments, fly ash is used to supplement the cement content. In some embodiments, the amounts of recycled foam and/or fly ash are adjusted so as to achieve an LEED certification. In some embodiments the volume percent of the components is about 20% to about 30% recycled foam, about 40% to about 60% sand, about 20% to about 30% cement, about 1% to about 10% water, and about 0.05% to about 0.15% additive. In some embodiments, at least a portion of the recycled foam is derived from one or more used molds that were used to cast architectural products

Some embodiments disclosed herein relate to a method of installing a precast architectural product comprising the steps of adhering a ledger to a surface using an adhesive, allowing the adhesive to substantially set before positioning a precast architectural product over the ledger also with the use of an adhesive where the architectural product features a channel on its back portion substantially corresponding to and mating with the ledger such that the weight of the architectural product is supported be the ledger even before the adhesive has fully set. In some embodiments, a mechanical fastener is used to affix the architectural product to the ledger. In some embodiments, particularly those where the architectural product is very heavy, a mechanical fastener is used to support the architectural product at least while the adhesive sets. In some embodiments, a pigment is applied to the architectural product before or after it has been installed, and, in some cases, a sealant is also applied to protect and maintain the pigment.

### BRIEF DESCRIPTION OF THE DRAWINGS

FIG. 1A is a perspective view of an architectural product installed on a surface.

FIG. 1B is an exploded view of an embodiment of an installation method for architectural products.

FIG. 2A is a perspective view of an embodiment of a precast architectural foam product.

FIG. 2B is another perspective view of an embodiment of a precast architectural foam product illustrating the rear portion.

FIG. 2C is another perspective view of an embodiment of a precast architectural foam product illustrating the rear portion.

FIG. 2D is another perspective view of an embodiment of a precast architectural foam product illustrating the rear portion.

FIG. 2E is another perspective view of an embodiment of a precast architectural foam product illustrating the rear portion.

FIG. 3A is a perspective view of an embodiment of a mold.

FIG. 3B is perspective view of an embodiment of a mold containing a foam product.

FIG. 3C is an exploded view of an embodiment of a mold and a precast foam product produced by the mold.

### DETAILED DESCRIPTION

The embodiments described herein generally relate to devices and methods for the manufacture and installation of precast architectural foam products. In some embodiments, the devices and methods disclosed herein can be used to fabricate and/or install architectural products regardless of whether the architectural products comprise foam in any form. Such architectural products can include decorate or structural pieces, pieces suitable for inside or outside installation, linear or circular pieces, pieces for attachment to a surface or pieces designed to be attached to itself or other pieces. Architectural products can be comprised of foam, recycled foam, foam salvaged from scraps, or materials other than foam that provide similar structural benefits.

### Precast Architectural Pieces and Installation Systems

As used in this disclosure, the term “precast” is used in accordance with its ordinary meaning in this field and includes a piece or product that has been cast in its final shape before positioning or installation. However, this does not preclude the possibility that a precast piece could be modified after it has been cast such as by cutting, sawing, sanding, painting, etc. Moreover, the term “precast” does not preclude the possibility of applying the teachings of the present disclosure to other processes such as an injection molded process.

As used in this disclosure, the term “ledger” is used in accordance with its ordinary meaning in this field and includes a shelf, rod, beam, block, or other shape or device that can be attached to a surface and can be used to at least partially support the weight of a precast architectural piece.

As used in this disclosure, the term “channel” is used in accordance with its ordinary meaning in this field and includes a groove, indentation, slot, or other surface feature capable of accepting a ledger-type object so as to take advantage of the support characteristics of the ledger-type object.

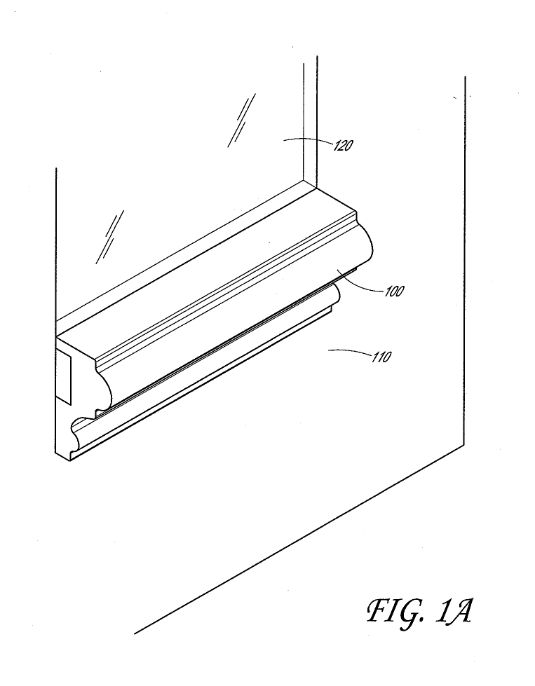

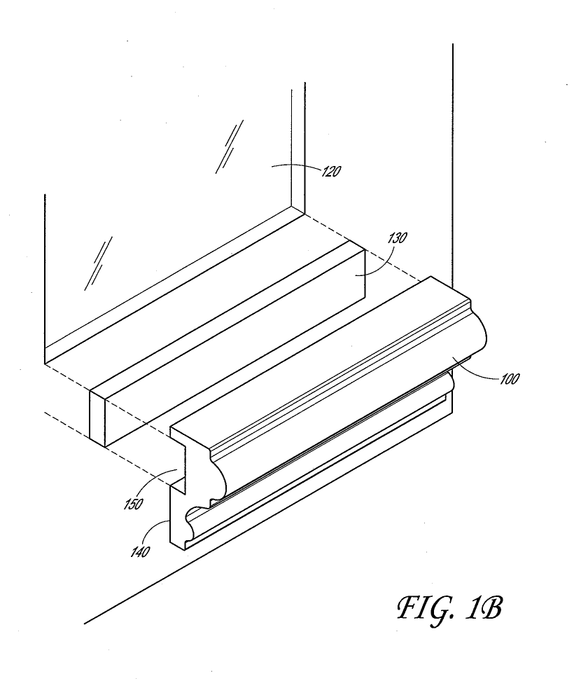

FIG. 1A illustrates a precast piece 100 according to some embodiments of the present disclosure installed on a surface 110. In some embodiments, the surface 110 is an exterior surface, and in some embodiments, the surface 110 is an interior surface. According to some embodiments, the precast piece 100 is installed along the periphery or edges of an opening 120 or other discontinuity in the surface 110. Examples of openings include, but are not limited to, windows, doors, exhaust vents, and void spaces. In some embodiments, one or more of the precast piece 100 is used to completely enclose or surround the opening 120 or a surface discontinuity. When such an arrangement is desired, the precast piece 100 comprises a unitary piece of precast material. However, multiple pieces may also be used. For example, four pieces could be used to line the four sides of a window. According to some embodiments, precast architectural products can be installed on interior or exterior surfaces.

FIG. 1B highlights one method that can be used to install the precast piece 100 as well as suitable materials for the installation. In some embodiments, an adhesive is used to attach or affix the precast piece to the surface 110. However, the weight of the precast piece 100 may to be too much for the un-set or adhesive before the adhesive is able to set or dry. FIG. 1B illustrates that a ledger 130 may be used to support the weight of the precast piece 100. In some embodiments, the ledger 130 is first attached or affixed to the surface 110. The channel 150 is then placed over the ledger 130 so that the precast piece 100 can be attached to the surface 110 with the ledger 130 acting as a support for the precast piece 100 at least while an adhesive sets or dries to hold the precast piece 100 firmly in place.

Any means of attachment known in the art could be used including, but not limited to, chemical adhesives and mechanical fasteners. In some instances, it is desirable to avoid puncturing the surface 110 or otherwise damaging or blemishing the surface 110 or damaging any water-resistant layers that may be associated with the surface 110 such as a layer of tar paper positioned behind the surface 110. To this end, mechanical fasteners can be excluded or used to puncture the surface 110 but not the water-resistant layer behind the surface 110. Mechanical fasteners tend to pierce the surface 110 and any water protective layer associated with the surface such as a layer of tar paper under the surface 110. Often the value of a water protective layer, waterproof layer, or water-resistant layer or materials depends on its structural integrity. Once a water protective layer is pierced, it is possible for water to pass through at the pierce or puncture point. In time this may lead to minor or major water damage to the surface 110 or the structure behind the surface 110 and the possible need to reinstall the precast piece 100 or even install an entirely new architectural product on the surface 110. Nevertheless, in some embodiments one or more mechanical fasters may be used to aid in the installation process particularly if the architectural piece to be installed is heavy. In some embodiments, because of the use of a ledger system, the mechanical fasters may be smaller than would otherwise be required to support the precast piece 100. Smaller mechanical fasters may do less damage to the surface 110 and/or any materials used to prevent water from passing through the surface 110.

The ledger 130 may comprise any material strong enough to support the precast piece and comprises an exterior surface to which one or more adhesives could form a bond. In some embodiments, the ledger 130 comprises a precast material similar to the material that forms the precast piece 100. In some embodiments, the ledger 130 comprises one or more pieces of foam such as Styrofoam or EPS foam, though other foams could also be used. In some embodiments, the ledger 130 comprises wood, metal, plastic, or a combination thereof.

It may be necessary to allow the adhesive used to install the ledger 130 to set. The amount of time required to set largely depends on the type of adhesive used. In some embodiments, as much as 24 hours may be required, though some embodiments may require more or less time. Liquid Nails® is one example of a suitable adhesive. Other examples include FoamTek, StyroGlue, AkroFlex, DryBond, AkroLoc, PolyLoc, Boncrete, all of which are produced by Omega Products International, though other manufacturers offer similar products or other products that are equally suitable. Additionally, adhesives such as those disclosed elsewhere in this disclosure could also be used.

Once the adhesive has adequately set or the ledger 130 has been otherwise attached to the surface 110, the precast piece 100 is installed over the ledger 130. In some embodiments, a back side 140 of the precast piece 100 including a channel 150 have been substantially coated with an adhesive. Examples of adhesives include those discussed above. In some embodiments, the presence of the channel 150 in the precast piece 100 means that no or few mechanical fasteners are required to support the weight of precast piece 100 while the adhesive sets or dries. In some embodiments, particularly where the precast piece 100 is particularly heavy or large, one or more mechanical fasteners are used to augment the support provided by the ledger 130 and the channel 150. In such embodiments, however, the size and intrusiveness of the one or more mechanical fasteners is less than would be required absent the ledger 130 and the channel 150.

According to some embodiments, a single ledger 130 may be used to support and install multiple precast pieces. For example, the length of an edge or door or other opening may require or be more amenable to the use of multiple precast pieces. And because of the size of such an opening, it may be difficult to ensure proper alignment of the architectural pieces along the edge or edges. Therefore, a single ledger can be used to more easily establish a line along an edge of the opening. In some embodiments, the ledger 130 is light and easy to place with precision without the need for supports or multiple people. This allows a single individual to establish a proper line along an edge first with the ledger 130 and to then sequentially install the smaller or shorter precast pieces as required.

However, two or more ledgers may also be used. This could be advantageous where the material utilized for the ledger 130 comprises scrap materials from which it may be difficult to obtain integral pieces long enough to be equal to or longer than the length of the channel 150.

According to some embodiments, each precast piece 100 is spaced about 1/16 of an inch from other precast pieces. In some embodiments, the spacing between each precast piece is greater or lesser depending on the functional or aesthetic needs of the application. In some embodiments, a grout material is applied to spaces between individual precast pieces; however, in some embodiments the grout material is not applied immediately after installation of the precast pieces. In some embodiments, it may be necessary to wait at least about 24 hours after installation. In some embodiments, more or less time is needed depending on the materials and/or adhesives as well as the climate or weather conditions such as rainy, wet, humid, dry, hot, etc.

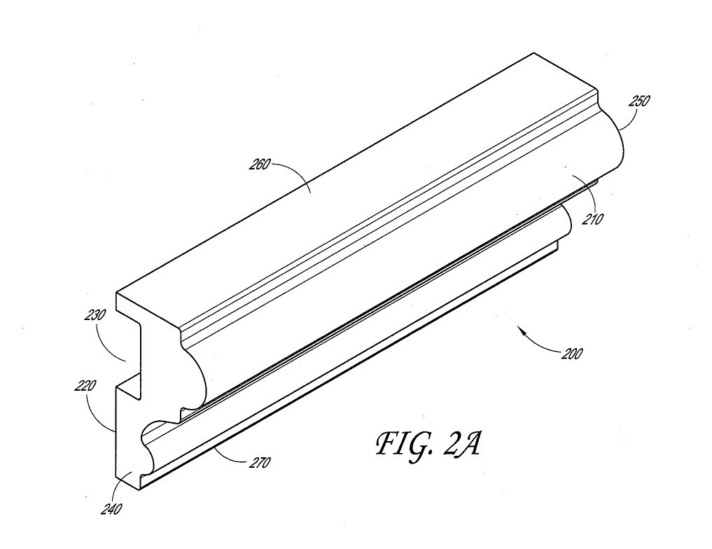

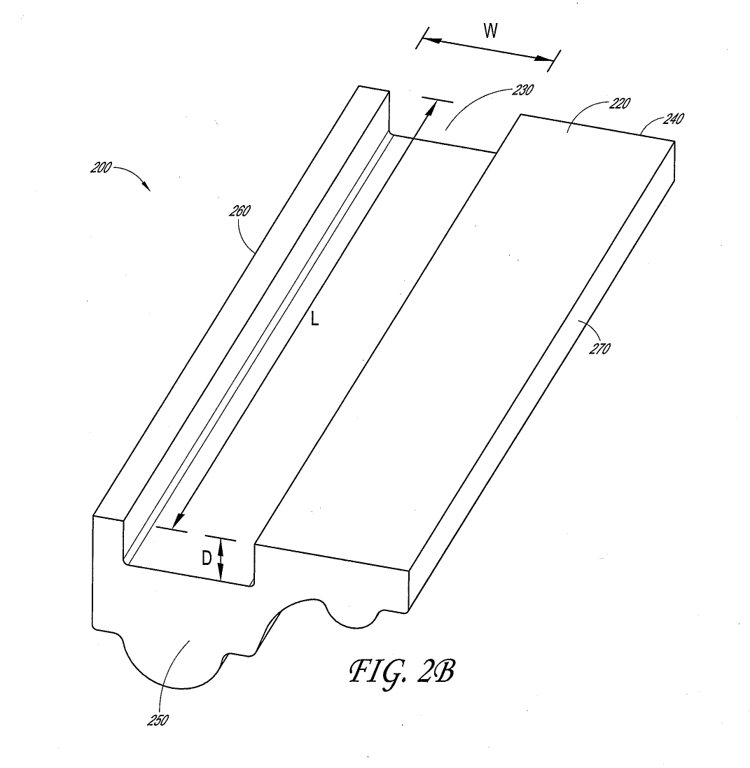

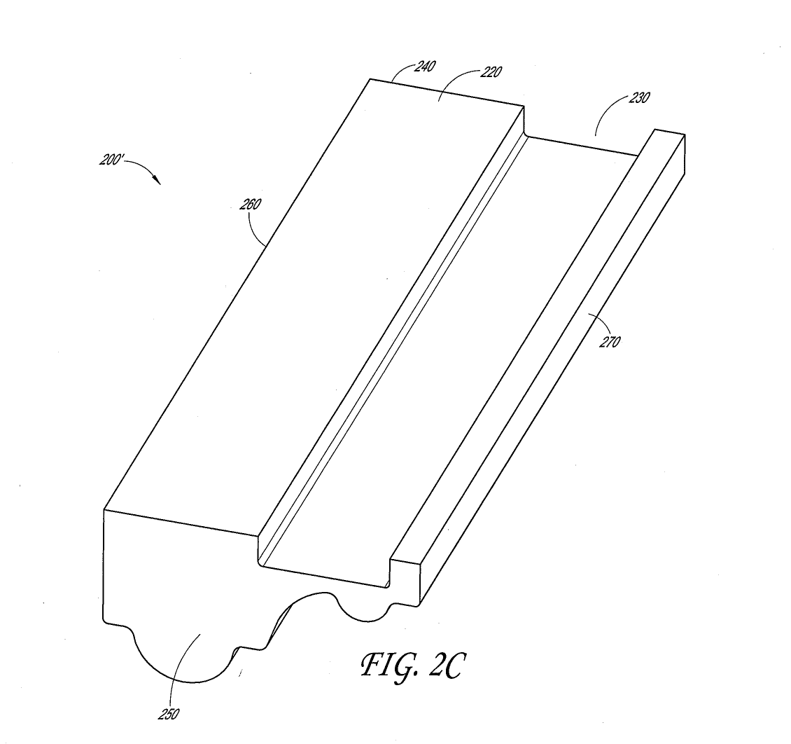

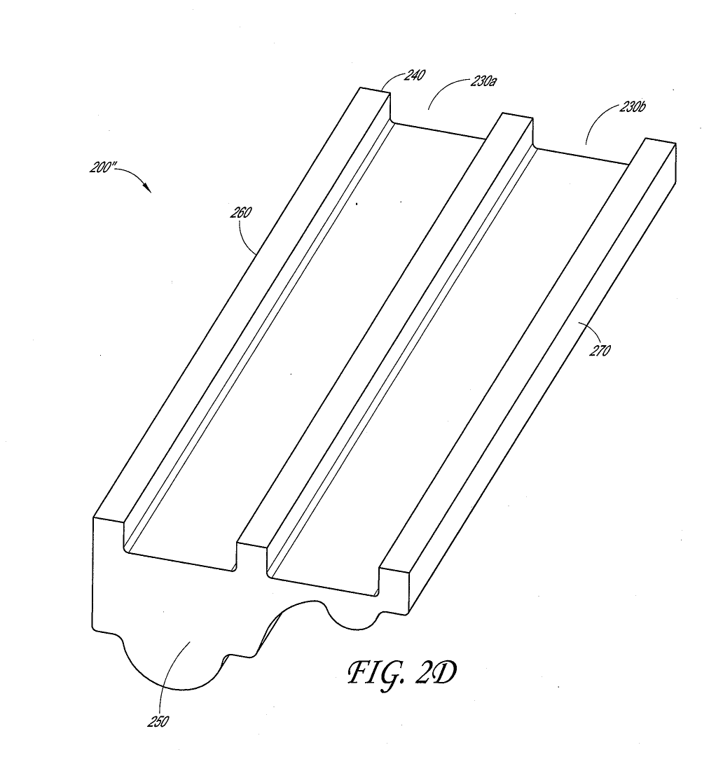

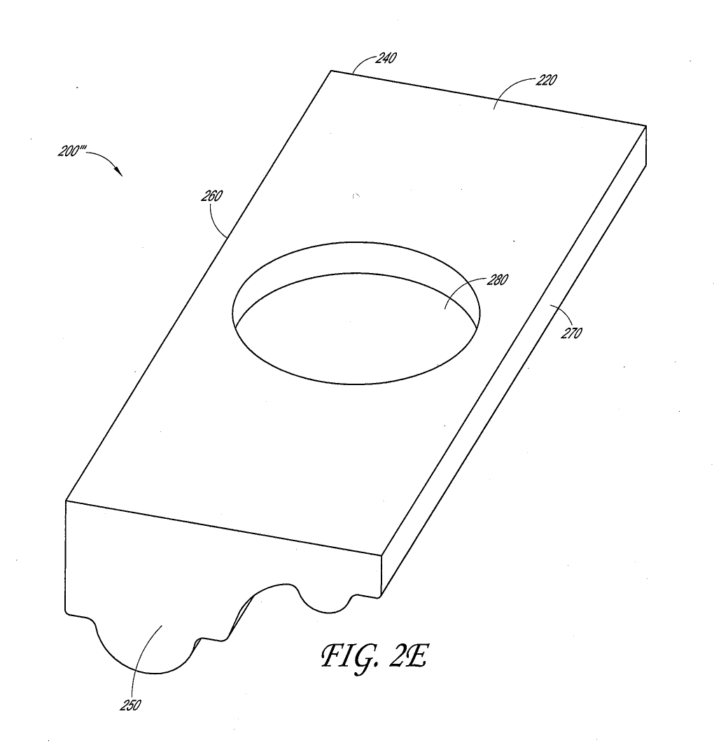

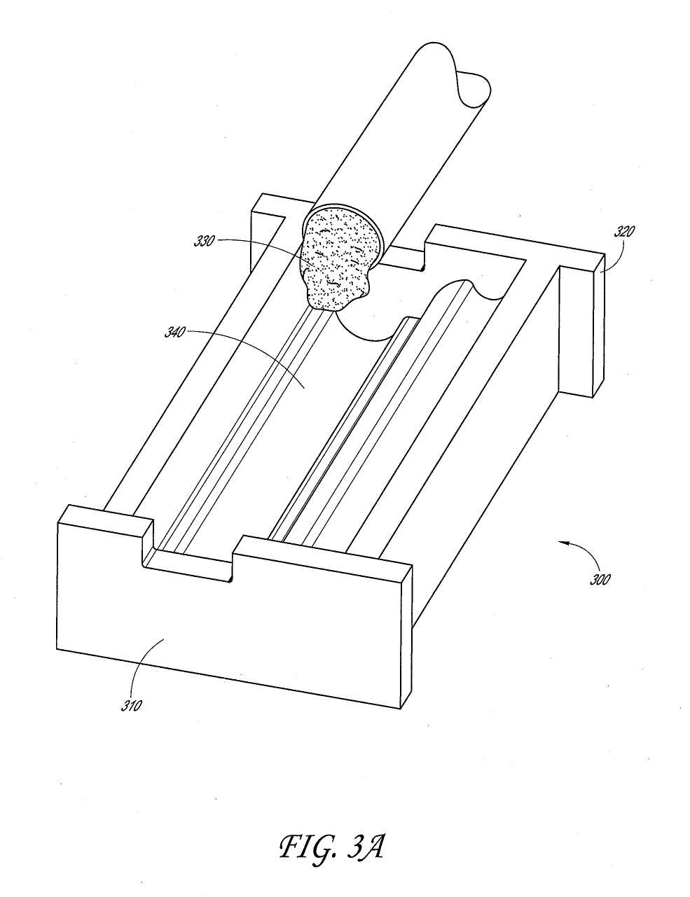

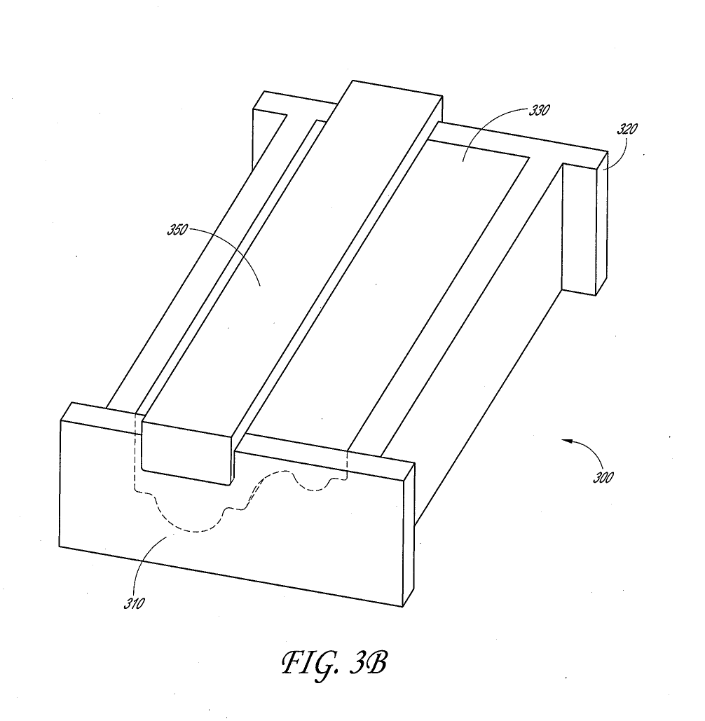

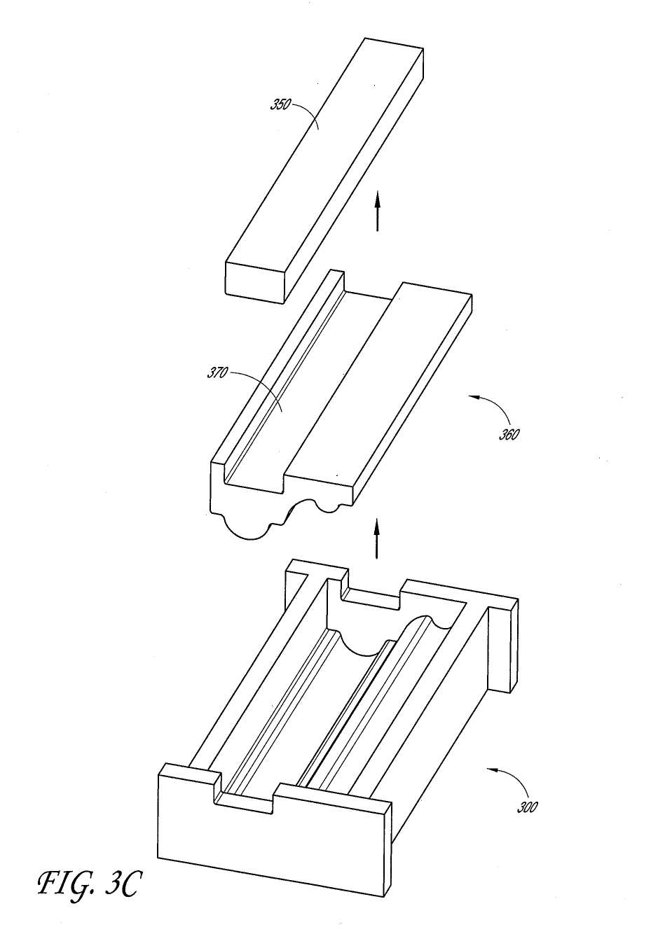

FIG. 2A illustrates a frontal perspective view of an embodiment of a precast piece 200 according to the present disclosure. The precast piece 100 comprises a decorative surface 210, a back portion 220, a channel 230 in the back portion 220, sides 240 and 250, a top portion 260, and a bottom portion 270. Regarding the decorative surface 210, its appearance, minor and major features or aspects, shapes, contours, etc. entirely depend on desired characteristics or aesthetics. All that is required is a suitable mold, which will be described in greater detail below with respect to FIG. 3A.

FIG. 2B illustrates a rear perspective view of an embodiment of a precast piece 200 according to the present disclosure. This view clearly illustrates a channel 230 in a back portion 220 of the precast device 200. In some embodiments, the length of the channel 230 runs the entire length of the precast piece. In some embodiments, the channel 230 runs only a portion of the length of the precast piece 200. For example, in some embodiments, the channel 230 begins at the side 240, but does not reach the side 250. In some embodiments, the channel 230 begins at the side 240, but does not reach the side 250. Moreover, in some embodiments, the channel 230 does not reach either side of the precast piece 200, but rather is displaced from either side by an equal or an unequal distance.

In some embodiments, the channel 230 is also described as an indentation in the back portion 220. This is because, it is not necessary the channel 230 have the general shape of groove running the length or any portion of the precast piece 200. It could be said that the channel 230 “mates” with a ledger, thought the term “mating” implies an approximate fit between both the channel 230 and a corresponding ledger. However, all that is required of the channel 230 is that it provide at least one surface that can contact and rest on or against a ledger, as described in reference to FIG. 1B.

In some embodiments, the channel 230 is configured to substantially match the contours of a ledger. According to some embodiments, substantially matching the contours of a ledger comprises a substantial match between all three of length, width, and height (or depth). In some embodiments, substantially matching the contours of a ledger comprises a substantial match between only two of length, width, and height (or depth). In some embodiments, substantially matching the contours of a ledger comprises a substantial match between only one of length, width, and height (or depth).

For example, in some embodiments in which a ledger having dimensions of 24 inches in length, 1 inch in width, and 0.5 inches in height, a channel in a precast piece may have dimensions of 24 inches in length, 1 inch in width, and 0.5 inches in depth. However channels of other dimensions could also be used such as channels deeper and/or wider than the ledger. Such configurations may be desirable to account for the thickness of an adhesive layer applied to the back portion 220. More space may be required if more adhesive is used. However, in some embodiments, the adhesive layer is preferably very thin such as one or two millimeters or less, in which case the dimensions of a channel need not vary much from the dimensions of a corresponding ledger.

According to some embodiments, the channel 230 is configured to have a depth less than the height of a corresponding ledger. This could be done to offset or space a precast piece from a surface. In some embodiments, the back portion 220 may occupy distinct planes which may provide for a spacing between a surface and the back portion 220 above the channel 230 while the back portion 220 below the channel 230 contacts the surface. If desired, a reverse configuration is also be possible.

Referring to FIGS. 2B and 2C, the channel 230 can located closer to either the top portion 260 or the bottom portion 270. In some embodiments, positioning the channel 230 closer to the top portion may provide better support for the precast piece while an adhesive sets. In some embodiments the channel is sufficiently spaced from the top portion 260, or the bottom portion 270 as the case may be, to ensure sufficient structural integrity within the precast piece 200 to hold the weight of substantially all of the precast piece 200. In some embodiments, the channel 230 abuts the bottom edge 270 so that one side of the channel 230 is exposed. In some embodiments, the channel 230 is positioned equally between the top portion 260 and the bottom portion 270.

Referring now to FIG. 2E, the precast piece 200 comprises more than one channel 230. In some embodiments, the multiple channels or indentations could be configured or arranged to accommodate design needs based on surface features of a wall or other surface. In some embodiments, the multiple channels or indentations are configured to provide greater stability or to better adhere to a surface.

Referring to FIG. 2B, the cross-sectional shape of the channel 230 can be dictated by the shape of the corresponding ledger. For example, a generally rectangular channel is to be used with a generally rectangular ledger. Referring to FIG. 2D, a circular or disc-shaped ledger is used, in which case a precast piece having a circular or square channel could be used. In some embodiments, the shape of the ledger does not dictate the shape of the channel 230 so long as the channel 230 and a ledger adequately contact each other to provide substantial support to a precast piece during installation. However, in some embodiments, the extent to which the shapes of the ledger and channel correspond may dictate the support or strength that the ledger can provide to an architectural piece.

According to some embodiments of the present disclosure, it is desirable to use mechanical fasteners to attach the precast piece 200 to a ledger. Such fasteners may be used only while the adhesive between the precast piece 200 and a surface sets or cures; however, such fasteners could also be used on a permanent basis. Embodiments of this configuration allow for the use of strong mechanical fasteners, while also preventing the mechanical fasteners from puncturing or otherwise damaging a surface and/or any associated water protection, waterproof layer, or water-resistant material.

### Molds for Precast Architectural Pieces

Generally, precast architectural products are formed using a mold whose interior surfaces have been shaped to provide the resulting architectural product with a desired surface configuration or visual appearance. According to some embodiments of the present disclosure, a mold used to cast an architectural piece is comprised of one or more foam materials. The use of foam materials reduces the cost of producing such molds both because foam materials generally cost less than many other materials and because foam materials are generally easier to cut or form into desired shapes. Moreover, the foam materials used to construct a mold can be used to cast multiple architectural products and later reused as raw material for the architectural products themselves. For example, in some embodiments, after at least one use the foam of a mold is broken apart and ground into fine particles or powder that is then mixed with other components to be poured into a new or different mold to form an architectural product.

According to some embodiments, the foam used in either the mold or the precast architectural product, or both, may be made of any type of foamed polymer that has sufficient strength to withstand the fabrication and installation processes as well as the varied weather conditions an architectural product will experience on the exterior of a building. Foam is any material containing a distributed mass of gas bubbles. According to some embodiments, the foam used may be made of a variety of foamed polymer materials including, but not limited to, expanded polystyrene, polyurethane, polyethylene, polypropylene, polyester, polyvinyl chloride, polyacrylonitrile, ABS, polyamide, polyoxymethylene, polycarbonate, rubber, phenolic, polyimide, acrylic, flouropolymer, epoxy, or silicone polymers.

Expanded polystyrene (“EPS”) is an excellent foam material because of its ease of processing, relatively low density, and relatively high strength. EPS is a generic term for polystyrene and styrene copolymers that are shaped, expanded, and molded into foam shapes. EPS may be purchased in large blocks having a density from about 1 lbs/ft³ or greater. In some applications, a density of about 1 lbs/ft³ to about 2.0 lbs/ft³ may be preferred. In other applications, a density under 1 lbs/ft³ may be desired. EPS may also be easily shaped by a computer-assisted foam-cutting machine that uses a hot wire to cut the EPS block into the desired three dimensional shapes.

FIG. 3A illustrates an embodiment of a mold 300 according to the present disclosure. In some embodiments, the mold 300 is formed from a solid Styrofoam product using a computer-assisted foam-cutting machine that provides a desired surface configuration. In some embodiments, the mold 300 is cut by hand from a solid piece of Styrofoam or other suitable foam. In some embodiments, the mold 300 comprises multiple pieces of components of foam or other suitable material. For example, in some embodiments, the mold comprises sides or endpieces 310 and 320, which may comprise the same or different materials as the rest of the mold 300.

In some embodiments, EPS foam is used. EPS foam is generally inexpensive, commercially available, and easy to process. In some embodiments EPS foam is used that has a density of about 1 lb/ft³, which is sufficient to provide an adequate surface finish on the exterior of the precast product. Of course, higher density EPS foam, with densities in the range from about 1.5 and 2 lb/ft³, may be used to provide a smoother surface finish. Recycled EPS foam on the other hand tends to provide a rough and inconsistent surface finish, but it may also be used to make any parts of the mold in addition to comprising a component of the slurry or mixture 330, which is discussed in greater detail below.

In addition to foam, the parts of the mold 300, may be made of any type of material including, but not limited to, metal, ceramic, glass, composite, wood, or plastic. Of course, use of these other materials may require different processing methods than what is described in the embodiments disclosed herein; however, such methods are known in the art. For example, a front pattern could be cut in metal using electrical discharge machining (“EDM”), standard machining processes, forging, or even casting. A plastic mold could be thermoformed or machined.

Obtaining a front pattern may include cutting an EPS foam block with a hot wire or computer-assisted foam-cutting machine that has been pre-programmed with the desired shape of the front pattern. The front pattern may also be obtained by thermoforming a plastic sheet over a model or using standard machining practices to obtain the desired shape of the front pattern. Alternatively, any method known in the art for making a suitable mold may be used to create the front pattern, such as molding, machining, or extrusion. Of course, the front pattern may be made from any metal, wood, plastic, ceramic, composite, or material capable of providing the precast product the desired shape while the slurry 230 comprising the architectural product cures.

In some embodiments, the endpieces 310 and 320 are affixed to mold 300 using adhesive. According to some embodiments, the adhesive may comprise hot glue or other material capable of bonding to the mold 300 to prevent the slurry 230 from leaking out. In some embodiments, mechanical fasteners such as nails, tape, clamps, etc. may be used instead of or in addition to one or more adhesives.

If a corner or miter joint is needed, one or more sides of the body of the mold 300 may be cut to a desired angle with the corresponding one or more endpieces attached to the side of the mold 300. In this way multiple architectural products can be assembled to form a joint. In some embodiments, the mold 300—having been cut at a given angle on one or more ends—is then aligned with and affixed to a second mold (not shown). By way of example, if a right angle is needed, both the mold 300 and the second mold may be cut at a 45 degree angle. The mold 300 and the second mold are then affixed in order to provide an integral architectural precast product with the appearance of a miter joint. According to some embodiments, other shapes and configurations may be desired, e.g., circles, semi-circles, corners, curves, etc.). In some embodiments, the mold 300 is scored to achieve an arched or radiused configuration for installation on a radiused surface, archway, or circular opening. In addition to forming the mold 300 to a desired shape or configuration, it is also possible to combine multiple molds as just discussed and to form the mold 300 such that each precast piece can be easily installed to achieve a desired configuration. Additionally or alternatively, a miter joint or other similar variation can be achieved by cutting one or both ends of the architectural product to a desired angle. A masonry saw may be used to perform this task, which is typically performed after the piece has been removed from the mold 300 and has sufficiently cured or set. In some cases, cutting the ends of the architectural piece rather than the mold 300 may be more desirable as it produces cleaner edges.

According to some embodiments, a lining or liner is applied to an inner surface 340 of the mold 300. The use of a liner can accomplish any number of desirable goals. In some embodiments, a liner is used to increase the number of times the mold 300 may be used to cast architectural pieces. In some embodiments, a liner is used to modify or smooth the surface of the architectural piece formed by the mold 300. In some embodiments, a liner aids in the removal process of a cast piece from the mold 300. In some embodiments, a liner is used to provide a surface feature on or in the resulting architectural product that would be difficult, impossible, or simply undesirable to accomplish with just surface contours of the interior surface 340 of the mold 300. In some embodiments, the same or a different lining is also applied to one or both of endpieces 310 and 320. In some embodiments, a lining comprises a single sheet of polymeric material. In some embodiments, a lining comprises a liquid, gel, or paste applied to the mold 300.

According to some embodiments, a lining comprises a plastic material or other material that aids in the removal of architectural product from the mold 300 and helps maintain the structural integrity of the mold 300 so that it can be used to fabricate multiple architectural products. In some embodiments, a lining comprises a polyurethane plastic also known as Visqueen or painters plastic.

In some embodiments, a lining is between 0.1 and 0.25 millimeters thick, and may be applied to the mold 300 using any suitable adhesive. However, in some embodiments, no adhesive is used. And in some embodiments, the thickness of the lining is greater or less depending on the characteristics of the mold and/or the desired characteristics of the precast architectural piece. Exemplary adhesives for affixing a liner to the mold 300 include, but are not limited to, 3M Fastbond contact adhesive 30NF; however other adhesives may work equally as well and may increase or decrease the time required to properly affix a lining or liner to the interior surface 340 of the mold 300.

According to some embodiments of the present disclosure, a heat vacuum applicator, also known as a heat lamp vacuum applicator, is used to dry the slurry or mixture 330 in the mold 300. Other devices may also be used to similarly apply heat and/or a vacuum to the slurry or mixture 330 to enhance the curing process. An enhanced curing process may result in a shorter curing time or a resulting architectural product with lower water content, though other results could be achieved by using a device such as a heat vacuum applicator. Using a heat vacuum applicator may require a thicker lining in the mold 300. A thicker liner can have the added advantage of being reusable in other molds when the mold 300 breaks down or otherwise becomes unusable after multiple uses.

According to some embodiments, the exposed interior surface or surfaces 340 of the mold 300 may be coated with a mold release for easier removal of the architectural product once it has set or partially set. In some embodiments, the exposed surface of a liner is coated with a mold release. Any number of mold release materials known in the art may be used including, but not limited to, silicon, Teflon, oil, or wax. For instance, some embodiments may utilize cooking spray as the mold release. Some mold release agents may dissolve or weaken the foam mold and thus should be avoided. In some embodiments, vegetable oil is used as a mold release. Other exemplary oils include ghee, olive oil, palm oil, soybean oil, canola oil, pumpkin seed oil, corn oil, sunflower oil, safflower oil, peanut oil, grape seed oil, sesame oil, argan oil, and rice bran oil. However, other materials such as butter may equally serve as a mold release. Moreover, in some embodiments, more than one mold release may be employed in the fabrication process.

Once the mold 300 is assembled, a cavity of the mold 300 is filled with a slurry or mixture 330 that hardens or cures to form a three-dimensional precast architectural product. In some embodiments, the mold 300 is vibrated while the slurry is poured in to reduce trapped air and to achieve a substantially uniform composition and density. Additionally, after the slurry 330 is poured into the mold 300, the mold 300 may be further vibrated. In some embodiments, the mold 300 is not vibrated at all until the cavity is filled with the slurry 330. The vibration helps remove air bubbles from the slurry. Vibrating the mold to remove air bubbles from the slurry usually increases the quality of the precast product. However, according to some embodiments more or less vibration or no vibration is used to achieve a desired consistency within the slurry and within the resulting precast product.

FIG. 3B illustrates an embodiment of a mold according to the present disclosure. In this illustration, the mold 300 has been filled with a slurry or mixture 330 that will form a precast architectural product. In some embodiments, the mold 300 also comprises a place holder 350 that will form a cavity or channel in the precast piece. In some embodiments, the mold 300 exhibits notches or openings in one or both of the endpieces 310 and 320 for accepting the place holder 350. According to some embodiments, the place holder 350 is positioned in the mold 300 before or after pouring of the slurry or mixture 330 into the mold 300. In some embodiments, the place holder 350 is positioned in the mold 300 after at least some of the slurry or mixture 330 has been poured into the mold 300.

In some embodiments, it may be necessary to attach the place holder 350 to the mold 300 so as to substantially prevent the force of the slurry or mixture 330 from moving the place holder 350 out of its desired position. Suitable attachment methods include adhesive applied between the place holder 350 and one or both of the endpieces 310 and 320 of the mold 300, mechanical fasteners such as nails, staples, clamps, etc.

According to some embodiments of the present disclosure, the place holder comprises the same or different material as the mold 300. In some embodiments, the place holder 350 comprises a foam material. In some embodiments, the place holder 350 comprises material more stiff than foam so as to be able to be forced into a slurry or mixture 330 that has already been poured into the mold 300. Similarly, a stiff material may be desirable to withstand the force of the slurry or mixture 330 as it is poured into the mold 300. In some embodiments requiring enhanced stiffness, any suitable may be used including foam provided it exhibits sufficient stiffness.

According to some embodiments, the place holder 350 comprises a relatively heavy material. In some embodiments, the place holder comprises a material having a density greater than the density of the slurry or mixture 330. Having a greater density helps maintain the place holder 350 in position so as to substantially prevent the place holder 350 from “floating” up or out of position. In some embodiments, the place holder, comprises a metal bar, rod, beam, or a relatively dense foam material.

According to some embodiments, the place holder 350 does not interact with the mold 300. For example, to achieve precast pieces with channels not extending the full length of the precast piece, it may be necessary to locate the place holder 350 onto the slurry or mixture 330 or push the place holder 350 into the slurry or mixture 330. In some embodiments, the place holder 350 comprises a material having a density substantially equal to or not much more or less than the density of the slurry or mixture 330 so as to allow the place holder 350 to stay in place in the liquid slurry or mixture 330 rather than sink to the bottom or float out of place. In some embodiments, the place holder 350 is attached to another piece that itself spans the length or width of the mold 300 so that the other piece can rest on the edges or endpieces of the mold 300 while the place holder 350 is pressed into an area of the surface of the slurry or mixture 330 not touching the mold.

FIG. 3C illustrates an embodiment of a method of removing a precast architectural product 360 from a mold 300. Once a slurry or mixture is poured into the mold 300 and the place holder 350, if desired or necessary, has been positioned in the slurry, it is necessary to allow the slurry to set, dry, or cure. In some embodiments, the slurry is allowed to set for about 48 hours. In some embodiments, a slurry is given more or less than about 48 hours. In some embodiments, it may be desirable to remove the precast product 360 prior to a complete curing or drying. In some embodiments, not allowing the product 360 to fully cure, may aid in the removal of the product 360 from the mold 300. In some embodiments, allowing the product 360 to fully cure outside the mold 300 may be advantageous for reasons other than removal such as a more homogenous structural composition, greater durability, or to apply pigments to the outer surface of the precast product 360 as is discussed in greater detail below.

In some embodiments, when the architectural product 360 is partially cured or after it is fully cured, the placeholder 350 is removed from product 360 and or the mold 300 leaving a channel 370 or cavity in the back portion of the product 360, and the product 360 is then itself removed from the mold 360. In some embodiments, the place holder 350 is removed from the cast product 360 after the cast product 360 has been removed from the mold 300. Once removed, the architectural product 360 may be sanded, polished, or subjected to other surface treatments to produce the desired surface finish. Of course, the surface finish of the front pattern within the mold 300 may directly affect the surface finish of the architectural product, depending of course on whether and what type of a lining is used. In some embodiments, if denser EPS foam is used as a front pattern, then the surface finish of the architectural product may be smoother. However, the same could be achieved with a proper lining thereby allowing cheaper or less dense foam to be used for the mold 300.

### Forming Precast Architectural Pieces

Some embodiments of mixtures for a precast architectural product comprise cement, foam, sand, and water. Some embodiments further comprise one or more additives. In general terms, the amount of water relative to the other ingredients is variable, though less water in some embodiments results in a stronger product. Moreover, the quantity of water used may depend on the water content of the sand as many sands contain or are delivered with a certain amount of water.

Described herein are various embodiments of compositions and mixtures for precast architectural products. In some embodiments, it is desirable to use foam as at least one of the components of the mixture or composition. In some embodiments, foam is relatively inexpensive and produces precast architectural pieces that are lighter and more malleable than architectural pieces that do not contain foam. In some embodiments, other ingredients include a cement material, sand, or water. Some embodiments also utilize one or more additives in addition to or in place of other ingredients, such as ingredients or additives that affect the drying time or the mixture or provide other enhancements to the mixture or the resulting precast product.

As used in the present disclosure, the term “cement material” is used in accordance with its ordinary meaning in this field and includes any substance that serves to bind or unite, a substance that hardens to act as an adhesive, or, more particularly, a building material made by grinding calcined limestone and clay to a fine powder that can be mixed with water and poured to set as a solid mass or used as an ingredient in in making mortar or concrete. An example of a suitable material is Portland cement.

Suitable foams include those discussed above. Additionally, recycled foams can be advantageously utilized. According to some embodiments, the foam is ground down to a grainy consistency. The particle size may vary depending on the desired texture of the architectural piece. In some embodiments, the average particle size may range from about 0.1 millimeters to about 1 centimeter. In some embodiments, the average particle size may range from about 0.5 millimeters to about 5 millimeters. In some embodiments, the average particle size may range from about 1 to 2 millimeters. In some embodiments, the average particle size may be greater than or equal to 0.1 millimeters and/or no larger than 5 millimeters.

According to some embodiments, the foam used in the composition is derived from previously used molds or other applications in which the foam would normally constitute refuse or scrap after use. In some embodiments, unused or new foam is used. In some embodiments, a mixture of used and unused foam is used. In some embodiments, the term “recycled foam” can be used to describe foams whose components were previously recycled or reused. An example of such a foam is eps360® from Benchmark Foam Incorporated.

Examples of suitable cement material include, but are not limited to portland cement, high aluminum cement, silicate cement, magnesium oxychloride cement, limestone coating material, or any other material known in the art having the qualities of cement. Polymeric binders and aggregates may be used to simulate stone and function as a cementitious material. In some embodiments, the cement material may also comprise fly ash or other recycled material.

According to the present disclosure, the following quantities may be used: 2 gallons cement, 2 gallons foam, 4 gallons sand, 1 quart water, and 1 fluid ounce of additive. However, those quantities can be varied. For example, the following ranges may be also be used: from about 1 gallon to about 3 gallons cement, from about 1 gallon to about 3 gallons foam material (which is ground or otherwise processed for use in a mixture), from about 3 gallons to about 5 gallons sand, from about 0.5 quart to about 1.5 quarts water, and about 0.5 fluid ounces to about 1.5 fluid ounces of an additive.

Consistent with the present disclosure, some mixtures may be used to produce very large or very small quantities so long as the general ratios or volume percentages of the ingredients remain the same. For example, in some embodiments, the percentage by volume of each ingredient could be as follows: about 10-40% cement, about 0.01-1% additive, about 0.5-10% water, about 10-40% foam, and about 30-70% sand. In some embodiments, percentages by volume are as follows about 20-30% cement, about 0.05-0.151% additive, about 1-5% water, about 20-30% foam, and about 40-60% sand. In particular embodiments, the percentages by volume are as follows: about 24% cement, about 0.1% additive, about 3% water, about 24% foam, and about 48% sand. These percentages are on a volume basis, and other percentages would possible on other bases such as weight, mass, density, etc.

Depending on the properties of the mixture that are desired, one or more distinct additives can be used. For example, suitable additives include at least the following grades of ADVA® admixtures available from Grace Construction Products: 140M 190, 195, 360, 370, 380, 405, 408, 575, 600, and FLEX. Other admixtures available from Grace Construction Products include EXP 950 and the following grades of Daracem®: 100, 19, and ML 330. Of course other admixtures can also be used especially those from other manufacturers that are substantially similar to those listed herein.

Suitable admixtures include accelerators, air-entraining agents, agents affecting alkali-silica reactivity, agents affecting calorimetry, color concrete, controlled low strength materials, corrosion inhibitors, high range water reducers, hydration stabilizers, macro fiber reinforced concrete, micro fiber reinforced concrete, microsilica, mid-range water reducers, pervious concrete, retarders, rheology modifying admixtures, self-consolidating concrete, shrinkage reducing admixtures, viscosity modifiers, water reducers, water repellant admixtures, workability enhancers, just to name a few.

According to the present disclosure, some embodiments also comprise pigments. In some embodiments, pigments are added to the mixture or the slurry prior to curing. In some embodiments, pigments generally in the form of paint are simply applied to the desired surfaces of the cured or partially cured product. In some embodiments containing pigments either throughout the mixture or simply applied to the surface of the product, a concrete sealer or sealant is applied to the outer surface of the precast piece to help maintain the appearance of the pigments over time.

According to some embodiments, precast architectural pieces are LEED certified. In some embodiments, an LEED certification is achieved by using a certain amount of recycled foam. In some embodiments, an LEED certification is achieved by replacing a certain amount of the cement component with fly ash. The amounts of recycled foam and/or fly ash can be adjusted not only to achieve varying degrees of LEED certifications, but modifications in other ingredients may also achieve other beneficial characteristics desirable in precast architectural product. Such characteristics can include increased strength, longevity, durability, ease of removal from a mold, more or less weight, greater or lesser density, ability to absorb and/or retain pigments, ability to be used in combination with mechanical fasteners, ability to be used with desirable adhesives, etc. In some embodiments, fly ash is used to replace as much as 35% of the cement content of a mixture. In some embodiments, fly ash is used to replace as much as 15% of the cement content.

According to the present disclosure, one or more kits may be assembled containing two more of the following elements: a mold (assembled or unassembled), ingredients (dry ingredients combined or uncombined), and a ledger. In some kits, water may be the only element not included. Some kits include a precast piece and a ledger and may further include one more mechanical fasteners or chemical fasteners.

While only some embodiments have been described in detail, it will be understood by those skilled in the art that the scope of the claims extend beyond the specifically disclosed embodiments to other alternative embodiments and/or uses and obvious modifications and equivalents thereof.

The following is claimed:

1. A reusable mold for a precast architectural product comprising:
an interior space having at least one contoured surface;
a liner adhered to at least a portion of the at least one contoured surface; and
a placeholder configured to create an indentation in the precast architectural product.

2. The reusable mold of claim 1, wherein the placeholder is configured to attach to the mold.

3. The reusable mold of claim 1, wherein the liner comprises a polyurethane material.

4. The reusable mold of claim 1, further comprising a release agent applied to an exterior surface of the liner.

5. The reusable mold of claim 1, wherein an adhesive is used to adhere at least a portion of the liner to at least a portion of the at least one contoured surface.

6. The reusable mold of claim 1, wherein the reusable mold comprises a foam material.

7. The reusable mold of claim 6, wherein the foam material is suitable for use as a component in a precast architectural product.

8. A mixture for a precast architectural product comprising:
foam;
sand;
cement; and
water.

9. The mixture of claim 8, wherein at least a portion of the foam comprises a recycled material.

10. The mixture of claim 8, further comprising at least one additive.

11. The mixture of claim 8, further comprising at least one pigment.

12. The mixture of claim 10, wherein the at least one additive comprises a water-reducing agent.

13. The mixture of claim 10, further comprising a fly ash material to supplement at least a portion of the cement.

14. The mixture of claim 13, wherein the amount of fly ash material and/or recycled foam is adjusted to achieve an LEED certification.

15. The mixture of claim 11, wherein the percentages of each component by volume are as follows: about 10-40% cement, about 0.01-1% additive, about 0.5-10% water, about 10-40% recycled foam, and about 30-70% sand.

16. The mixture of claim 11, wherein the percentages of each component by volume are as follows: about 24% cement, about 0.1% additive, about 3% water, about 24% foam, and about 48% sand.

17. The mixture of claim 9, wherein at least a portion of the recycled foam comprises foam material derived from at least one used mold for a precast architectural product.

18. A method of installing a precast architectural product comprising the steps of:
adhering a ledger to a surface using a first adhesive;
allowing the first adhesive to substantially set;
applying a second adhesive to a back portion of the precast architectural product wherein the back portion comprises a channel;
positioning the channel on the back portion of the precast architectural product over the ledger; and
pressing the precast architectural product against the surface such that the second adhesive fully contacts both the ledger and the surface.

19. The method of claim 18, further comprising adhering the precast architectural product to the ledger with at least one mechanical fastener.

20. The method of claim 18, further comprising maintaining the precast architectural product in place with at least one mechanical fastener while the second adhesive sets.

21. The method of claim 18, further comprising applying a pigment to at least a portion of the precast architectural product.

22. The method of claim 21, further comprising applying a sealant to at least a portion of the precast architectural product before or after installation.
